(19) United States
(12) Patent Application Publication
(10) Pub. No.: US 2013/0141007 A1
(43) Pub. Date: Jun. 6, 2013

(54) MODULAR LED POWER SYSTEM WITH CONFIGURABLE CONTROL INTERFACE

(71) Applicants: Matthew C. Wood, Harrisburg, PA (US); Mohammad S. Ahmed, Harrisburg, PA (US); Stephen M. Jackson, Mount Joy, PA (US)

(72) Inventors: Matthew C. Wood, Harrisburg, PA (US); Mohammad S. Ahmed, Harrisburg, PA (US); Stephen M. Jackson, Mount Joy, PA (US)

(73) Assignee: TYCO ELECTRONICS CORPORATION, Berwyn, PA (US)

(21) Appl. No.: 13/310,187

(22) Filed: Dec. 2, 2011

(51) Int. Cl. H05B 37/02

(52) U.S. Cl. 315/291

(57) ABSTRACT

A modular system and method for providing power for LED lighting systems. The power source unit comprises (1) a power supply that converts A/C voltage to regulated D/C voltage, (2) a configurable intelligent gateway module that receives the regulated D/C voltage and places it on a power bus to which one or more power node modules and any accessories in need of power, such as motion detectors or cooling units, are coupled, and (3) an intelligent power node module that converts the regulated D/C voltage to a regulated D/C current and provides it to the particular LED Light Module (LLM), and which also receives data from the LLM, such as temperature data, and adjusts the regulated current accordingly. The gateway module also may receive control data from control devices, such as dimmers or wireless controllers, and instruct the power node module to regulate its output current accordingly.

### FIELD OF THE INVENTION

The invention pertains generally to the powering and control of solid state lighting systems, such as LED (Light Emitting Diode) lighting systems.

### BACKGROUND OF THE INVENTION

LED lighting systems are increasingly being used for illumination in business environments, such as stores, offices, and entertainment venues, as well as homes for general and decorative lighting purposes. LED lighting has many significant advantages over incandescent, fluorescent, and other lighting systems. For instance, they consume less power relative to the amount of light produced as compared to alternatives. Additionally, LEDs have a longer lifespan than most alternatives. Yet further, LEDs are sturdier than most other alternatives because there is no filament or other mechanically sensitive parts, as there are in incandescent and fluorescent light bulbs.

LED lighting systems operate on relatively low voltage compared to incandescent, fluorescent and other lighting systems. LED lights are powered by a regulated D/C current, rather than an A/C voltage.

Because LEDs generally output relatively small amounts of light per diode, most LED lighting systems use a plurality of LEDs to produce sufficient light. This may be accomplished in many forms, including (1) a linear array of LEDs to produce a long thin tube of relatively constant light output, looking much like a fluorescent tube light, (2) placing a cluster of LEDs in close proximity to each other within a bulb that resembles a conventional incandescent light bulb, and (3) stringing together a series of LED lights (like a string of holiday decorative lights).

Since LED lighting systems require regulated current and operate at relatively low voltages, a power system typically must be interfaced between the LEDs and the relatively high A/C voltage power typically available through the power grid in most countries, such as the 120 volt A/C power available in the United States and the 230 volt A/C power available throughout most of Europe. The power system must convert the incoming relatively high voltage A/C power to a regulated D/C current output tailored to the particular LED lighting system. The power system also must be able to adjust its output current responsive to a temperature signal from the LED Lighting Module (LLM) and to any control devices (e.g., dimmers or motion sensors) included in the lighting system.

The desired regulated D/C current for an LED lighting system depends on many different factors, such as the number of LEDs in the lighting system, the manner in which they are intercoupled (e.g., parallel and/or series), the control devices incorporated into the lighting system (e.g., dimming), and the temperature of the LEDs. Hence, different LED lighting systems require different power systems.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present basic concepts in a simplified form as a prelude to the more detailed description that is presented later.

The invention is a modular system and apparatus for providing power for LED lighting modules. The power source of the present invention comprises (1) a power supply unit that outputs a regulated D/C voltage, (2) a configurable, intelligent gateway module that receives the regulated D/C voltage from the power supply and passes it to one or more power node modules on a power bus as well as to any control device or accessory in need of power, such as a motion detector or a cooling unit. The gateway module also receives control data from one or more control devices, such as a dimmer or a wireless controller, and instructs the power node to regulate the current according to any such control signals, and (3) an intelligent power node module that converts the regulated D/C voltage to a regulated D/C current to power the particular LED Light Module (LLM) and which also receives data from the LLM, such as temperature data, and adjusts the regulated output current accordingly.

### DESCRIPTION OF THE DRAWINGS

FIG. 1 is a block diagram illustrating an LED lighting system in accordance with a first embodiment of the invention.

FIG. 2 is a block diagram illustrating an LED lighting system in accordance with a second embodiment of the invention.

FIG. 3 is a block diagram illustrating an LED lighting system in accordance with a third embodiment of the invention.

FIG. 4 is a block diagram illustrating an LED lighting system in accordance with a fourth embodiment of the invention.

FIG. 5 is a block diagram illustrating an LED lighting system in accordance with a fifth embodiment of the invention.

FIG. 6 is a block diagram illustrating the internal components of the various modules of an LED lighting power system in accordance with one embodiment of the invention.

FIG. 7 is a block diagram illustrating the internal components of the various modules of an LED lighting power system in accordance with another embodiment of the invention.

FIG. 8 is a block diagram illustrating the internal components of the various modules of an LED lighting power system in accordance with yet another embodiment of the invention.

FIG. 9 is a block diagram illustrating the internal components of the various modules of an LED lighting power system in accordance with one more embodiment of the invention.

FIG. 10 is a block diagram illustrating the internal components of the various modules of an LED lighting power system in accordance with yet one more embodiment of the invention.

### DETAILED DESCRIPTION

As noted above, different LED lighting modules have different current requirements. Hence, every LED lighting system having a different current requirement must have a different power supply system. In fact, even lighting systems with the same power requirements may require different power supply systems as a result of different features or accessories included with the system. For instance, control devices, such as motion sensors and dimmers, and accessories, such as fans and other cooling accessories, may have their own unique power requirements. In addition, such control devices and accessories may output data that the power supply must be able to understand and respond to in order to provide the desired functionality.

Hence, power supplies for LED lighting systems are manufactured in small quantities, thus raising their cost. In addition, the design time to develop and implement a typical new power supply for a new LLM or to accommodate a new accessory or control device in an old LLM typically is on the order of eight to nine months.

The present invention substantially reduces or completely eliminates the cost and time of developing new power supplies for LLMs by providing a modular system that can work with a wide variety of LED lighting modules (LLMs), accessories, and control devices using virtually any off-the-shelf power source for generating a regulated D/C voltage output.

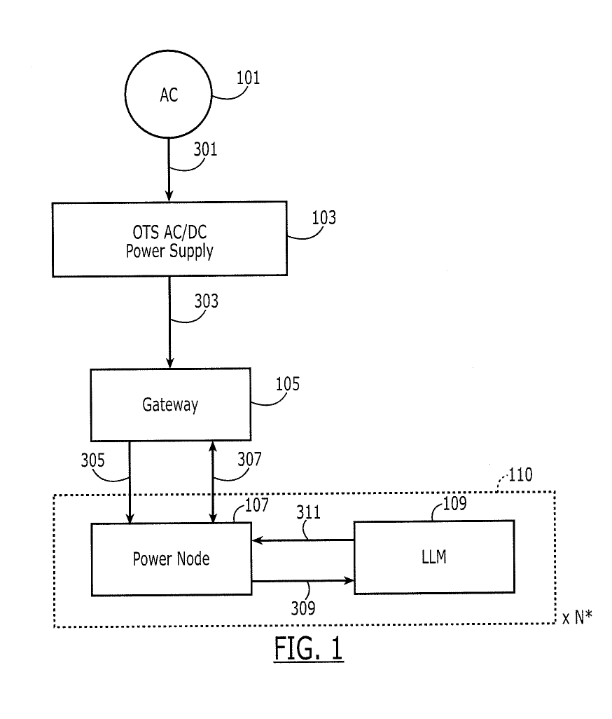

FIG. 1 is a block diagram of a simple LED lighting system 100 in accordance with the principles of the present invention. Power is provided to the system on line 301 from a conventional A/C power source 101, such as 120 volts of A/C widely available in the United States or 230V of A/C power widely available in Europe, to the first module of the system, which is an A/C to D/C voltage converting power supply 103. The A/C to D/C power supply module 103 converts the incoming A/C voltage to a regulated D/C voltage output on line 303. Due to the modular design of the system, virtually any off-the-shelf power supply 103 can be used for this first stage because the intelligence in the system is contained in other modules of the system.

The power source may be any power source that outputs a regulated D/C voltage, including, but not limited to, batteries, solar panels, and A/C to D/C converters.

The next module is a gateway module 105. This module contains intelligence, such as a microprocessor, microcontroller, digital signal processor (DSP), field-programmable gate array (FPGA), complex programmable logic device (CPD), application-specific integrated circuit (ASIC) or any other form of digital processing apparatus. As will be discussed in more detail below, the intelligence in the gateway module 105 interfaces with control devices, such as dimmers, motion sensors, and wireless controllers to receive lighting control signals via either a communication bus 307 or a dedicated connection, and interfaces with the power node modules 107 via the communication bus 307 to control the LLM(s) 109. The gateway module 105 also places the regulated D/C voltage received from the power supply module 103 on a power bus 305, from which the power node modules 107 draw power. Any lighting accessories and control devices also may draw power from the power bus 305 either directly or through a power node. Finally, the gateway module maintains and controls the voltage power bus 305 and communication bus 307.

A word with regard to terminology in this specification is in order at this point. Herein, the term “power system” refers to the overall system for powering an LLM. For instance, this includes, but it not necessarily limited to, power supply node 303, gateway node 105, power node 107 and the power and communication buses 305, 307. The term “power supply” refers to the portion of the power system that outputs a regulated D/C voltage, e.g., power supply module 103. Finally, “power node” is a coined term to refer to the module in accordance with the present invention that converts the regulated D/C voltage to a regulated D/C current, among other things, e.g., power node module 107.

One or more power node modules 107 also are intelligent modules, containing microcontrollers (or other signal processing devices). FIG. 1 shows an embodiment with one power node 107 and one LLM 109. However, there may be as many LLMs 109 and corresponding power node modules 107 on the system as can be supported by the amount of power available from the power supply 103. The power node modules 107 are coupled to the power bus 305 and the communication bus 307. The power node modules may be coupled in parallel to the bus or may be daisy-chained. The gateway module can be configured to send different instructions to different power nodes using any conventional network addressing scheme used in connection with the buses.

The power node module 107 receives the regulated D/C voltage on the power bus 305 from the power supply module 103 through the gateway module 105 and converts it to a regulated D/C current, which is provided to the LLM 109 on line 309 to produce light. In addition, the power node module 107 may receive instructions from the gateway module 105 over the communication bus 307, such as instructions generated responsive to control signals the gateway module 105 received from a dimmer or a motion sensor. The microcontroller in the power node module 107 interprets any instructions received from the gateway module 105 over communication bus 307 and controls the regulated D/C current output on line 309 to the LLM 109 accordingly. For instance, if a dimmer control device sends a signal to the gateway 105 indicating that fifty percent power is desired, the intelligence in the gateway 105, which is programmed to understand the language of the dimmer, interprets the command from the dimmer, generates a command to reduce current by fifty percent in the language of the communication bus 307 and addresses it to the proper power node module 107 on the communication bus. In response, the intelligence in the power node 107 regulates the regulated D/C current to the LLM 109 at the required level, e.g., fifty percent of its maximum amplitude.

The power node 107 can also receive local temperature or other data from the LLM 109 on line 311. More particularly, LED efficacy is dependent on local temperature. Thus, LLMs commonly generate a temperature signal that the power system uses to adjust the current applied to the LLM in order to keep it operating within a particular temperature range. This temperature signal is provided to the power node module 107 on line 311 and the intelligence in the power node module 107 adjusts the regulated D/C current output on line 309 responsive to the temperature signal (in addition to any control signal received from a control device, either directly or through the gateway module 105.) LLMs also may generate other information useful to the power node in terms of adjusting the output current, such as color temperature and flux level, which can be provided to the power node module on line 311.

In an alternative arrangement, the power node module 107 passes the temperature, color, flux, etc. information to the gateway module 105 via the communication bus 307. The intelligence in the gateway module 105 combines that information with any control information received from a control device and instructs the power node module 107 via the communication bus 307 of the proper current level it should output to the LLM 109 and the intelligence in the power node module regulates the output current 309 accordingly.

The number of power node/LLM units 110 that can be powered by a single power supply 103 is given by the following equation:

N<(P_{out(supply)}−P_{overhead})/(Pₗₗₘ/Eff_{node})
where
N=the number of power node/LLM units 110 that can be powered;
P_{out(supply)}=the maximum output of the power supply (e.g., in watts);
Pₗₗₘ=the maximum power consumption of the LLM;
Eff_{node}=the efficiency of the power node module; and
P_{overhead}=any overhead power requirements, such as the power consumed by the gateway module 105 or in wires.

Since the power bus 305 directly carries the regulated D/C voltage output from the power supply module 103, a voltage for running voltage based accessories, such as cooling units and motion sensors, is available at each power nodes.

Further, by splitting the power source into three modules, namely, the power supply module 103, the gateway module 105, and the power node module 107, the power source for LLM units is highly adaptable at relatively low redesign and hardware costs. Particularly, with this configuration, the A/C to D/C power supply 103 can be almost any off-the-shelf power supply. Only the gateway module 105 and the power node module 107 need be adapted to the particular LLM, control devices, and/or accessories. Furthermore, the gateway module 105 and the power node module 107 typically will require only programming modifications, rather than hardware modifications, in order to be adapted to operate with different LLMs, control devices, and accessories.

In one embodiment, the power node module 107 is preprogrammed at the factory to the LLM to which it is coupled. For instance, its maximum D/C may be output current set according to the specification of the LLM. In operation however, the output D/C current can be adjusted downwardly therefrom as a function of the LLM temperature and any control devices.

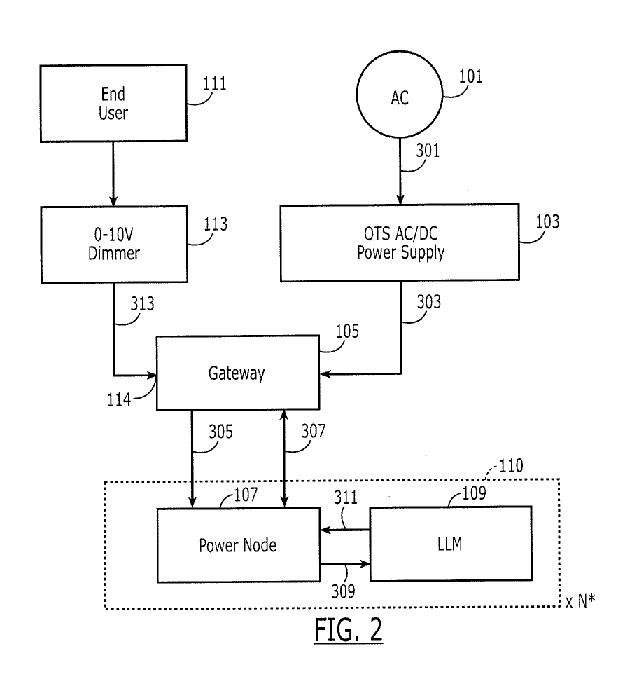

FIG. 2 illustrates another implementation of the invention, this one in a system that includes a zero to ten volt dimmer 113. This embodiment is similar to the embodiment of FIG. 1 except for the addition of a control device, namely, the zero to ten volt dimmer 113. As before, the power supply module 103 converts A/C voltage to regulated D/C voltage, which is provided through the gateway module 105 to the power bus 305 and through the power bus, to the power node module 107. The power node module 107 converts the regulated D/C voltage to a regulated D/C current and supplies it to the LLM on line 309. The LLM provides temperature or other sensed data to the power node on line 311. In this embodiment, the power node module 107 feeds the temperature data to the gateway module 105, which instructs the power node module 107 as to the regulated current that must be output to the LLM responsive to the temperature.

In addition, however, a dimmer 113 is coupled to provide control signals to control input terminals 114 of the gateway module 105 on a dedicated line 313. When an end user 111 operates the dimmer 113 to set a desired illumination from the LLM 109, the dimmer outputs its control signals, (e.g., fifty percent power) to the gateway module 105, which may have been preprogrammed at the factory to interface with control devices using particular protocols. For instance, there is a widely used protocol for zero to ten volt dimmers. Other well known protocols include DALI (Digital Addressable Lighting Interface) having a protocol set forth in technical standard IEC 62386, DMX 512. Alternately, the intelligence in the gateway module may be equipped with programming to communicate using multiple protocols and include intelligence for determining on-the-fly the protocol being used by a control device that is coupled to it. The intelligence in the gateway node 105 may combine the control information from the dimmer 113 with any temperature information and send an instruction to the power node module 107 on communication bus 307 as to the proper regulated current to output to the LLM 109 to produce the desired illumination.

The gateway module in FIG. 2 may be physically identical to the gateway module in FIG. 1. In the FIG. 1 environment, however, there may be nothing connected to the control input terminals of the gateway node, whereas, in FIG. 2, dimmer 113 is coupled to the control input terminals 114. As before, there can be a plurality of combined power node and LLM units coupled to the regulated D/C voltage bus 305 and communication bus 307.

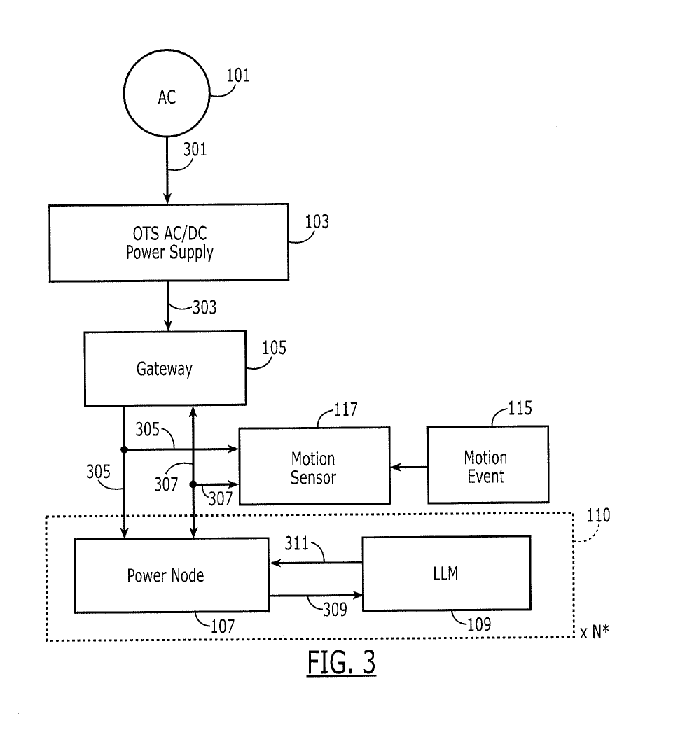

FIG. 3 shows yet another implementation in accordance with the principles of the invention. This implementation is similar to the implementation of FIG. 1, except for the addition of a different control device, such as motion sensor 117, coupled within the system in a different way than dimmer control device 113 of FIG. 2. In this embodiment, the motion sensor 117 is coupled to receive power in the form of a regulated D/C voltage from the power bus 305. Furthermore, the motion sensor control device 117 places its data on the communication bus 307 to the gateway module 105, rather than via a dedicated line 113 and terminal 114. Responsive to control signals from motion sensor 117, the gateway module 105 sends instructions to the power node module 107 to control the LLM 109 accordingly. For instance, the gateway node 105 will instruct the power node 107 to cut off all current to the LLM when the motion sensor 117 does not detect motion for a predetermined period after the last motion event 115 was detected.

Since the power node 107 has intelligence and also is coupled to the communication bus 307, in other embodiments, the power node 107 may receive the commands from the motion sensor directly via the communication bus and interpret them itself without the involvement of the gateway node 105; particularly if there is only one power node and LLM in the system, such that the motion sensor need not deal with addressing of the motion sensor control signals.

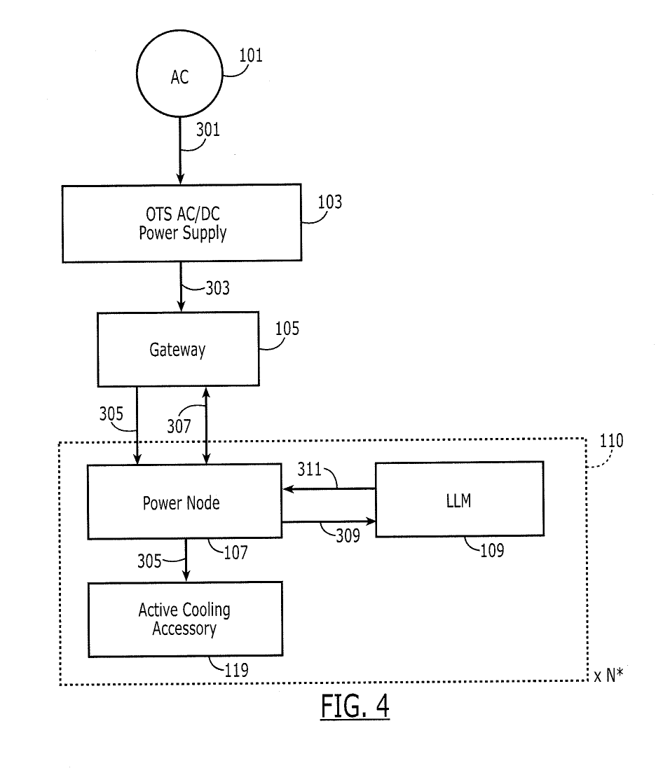

FIG. 4 illustrates yet another embodiment in which an LED lighting accessory 119 is powered via the power node module 107. For instance, in the illustrated embodiment, the accessory 119 is a cooling unit for cooling the LLM 109. This embodiment is substantially similar to the embodiment of FIG. 1, except for the addition of the active cooling unit 119. Since the gateway 105 passes the regulated D/C voltage output from the power supply 103 directly through to the power node 107, the regulated D/C voltage on voltage bus 305 is available at the power node 107 to power the cooling accessory 119. The power node 107 may provide a separate port for coupling the accessory to the power. However, it should be understood that that port may be nothing but a connection to the power bus 307. Thus, one of the advantages of providing the regulated D/C voltage 307 to the power node 107 is that each power node 107 is capable of providing power to accessories for the corresponding LLM 109.

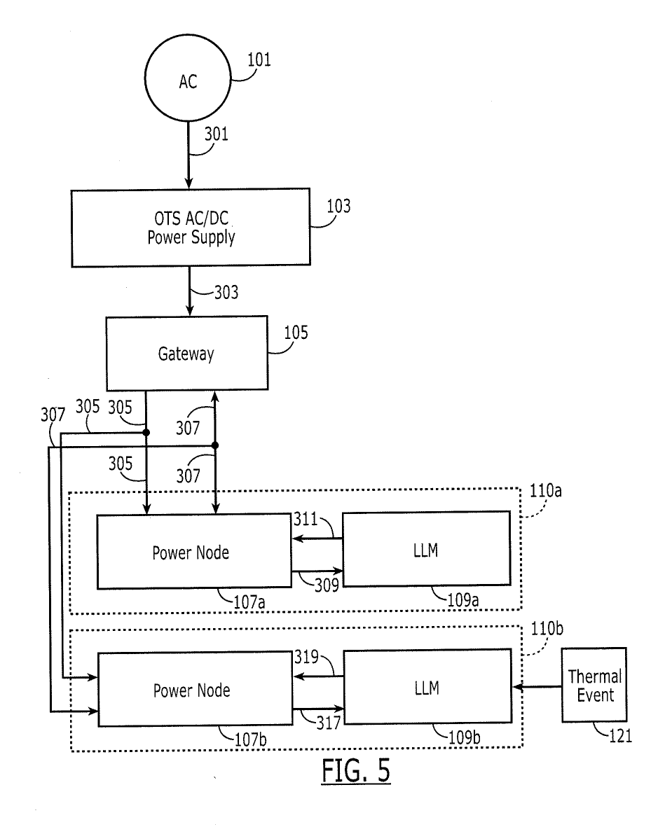

FIG. 5 illustrates yet another embodiment of the invention. This embodiment is substantially similar to the embodiment in FIG. 1, except that it illustrates a plurality of (two) power node/LLM units 110a and 110b connected in parallel to the gateway module 105. Illustrated by FIG. 5 is the fact that each power node module 107 can be controlled individually by the gateway 105. For instance, a thermal event 121 on one of the LLMs 109b, such as an overheat situation, may cause the LLM 109b in power node/LLM unit 110b to shut down without affecting power node LLM unit 110a. The thermal event is reported by the LLM 109b to the power node 107b via communication line 319.

In one embodiment, the power node 107b may have the intelligence built into it to automatically adjust the current output on line 317 responsive to the thermal event 121, such as by shutting off the current to turn off the LLM 109b. In other embodiments, however, the intelligence for responding to temperature information and thermal events may reside in the gateway module 105, in which case the intelligence in the power node module 107b merely reports the thermal event 121 to the gateway module 105 via the communication bus 307 and receive instructions from gateway module 105 via the same communication bus 307.

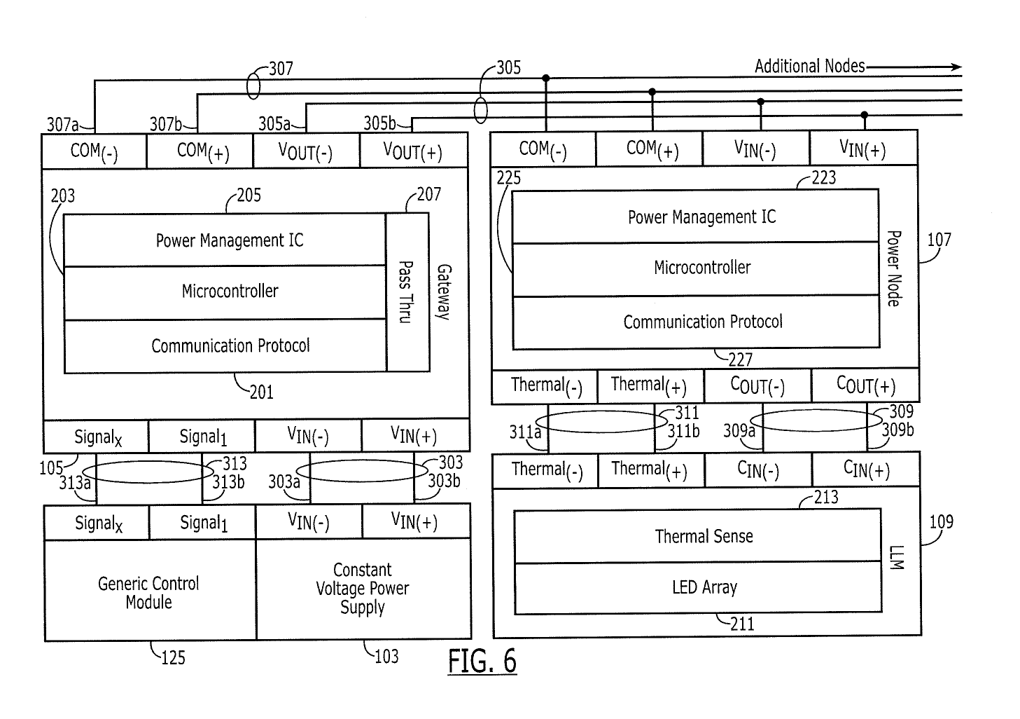

FIG. 6 is a block diagram illustrating some of the details of the various modules shown in the LLM system of FIGS. 1-5. FIG. 6 corresponds substantially to the embodiment shown in FIG. 2. Particularly, as in FIG. 2, the constant voltage power supply module 103 provides a regulated D/C voltage to the gateway module 105 via power lines 303 (comprising positive and negative lines 303a and 303b). Furthermore, the control device 125, which, for instance, may be the dimmer 113 of FIG. 2, sends command signals to the gateway module 105 via signal path 313 (comprising differential signal lines 313a and 313b).

Turning to the details, the gateway module 105 comprises four functional parts. The first is a communication protocol functional block 201. This block interprets the signals from the control module 125 to determine what the signals mean. This block 201 may be preprogrammed at the factory. Further, there is a power management integrated circuit 205 that powers all the circuitry in the gateway module 105 from the voltage from the constant voltage power supply module 103. The power management integrated circuit 205 monitors for under voltage or over voltage conditions and can shut off power in either case to prevent damage to the LLM. In addition, a microcontroller 203 receives the interpreted signals from the control device 125 and generates suitable commands for the power node module 107 and places them on the communication bus 307. Finally, the gateway module 105 includes a pass through block 207 for passing the regulated D/C voltage straight through to the power node module 107.

The power node module 107 comprises a constant current regulator 227 that receives the regulated D/C voltage and converts it into a regulated D/C current. A power management integrated circuit 223 manages power requirements on the power node module 107 as well as any accessories that might be coupled to receive power from the power node module. The power management integrated circuit 223 regulates the current for the microcontroller 225 and any other electronics in the power node module 107. Finally, a microcontroller 225 provides the intelligence for communicating with the gateway module 105, receiving and reading temperature information from the LLM 109, communicating with and controlling accessories, and the like. The power node module 107 is coupled to the LLM 109 by four lines, namely, the current supply line 309, comprising lines 309a and 309b, and the temperature data input lines 311, comprising differential signal lines 311a and 311b.

Finally, the LLM 109 comprises the LED array 211 as well as the thermal sensing circuitry 213. The current on lines 309a and 309b is provided to the LED array 211 while the thermal data generated by the thermal sensing circuitry 213 is provided to the power node module 107, via the thermal signaling lines 311a and 311b.

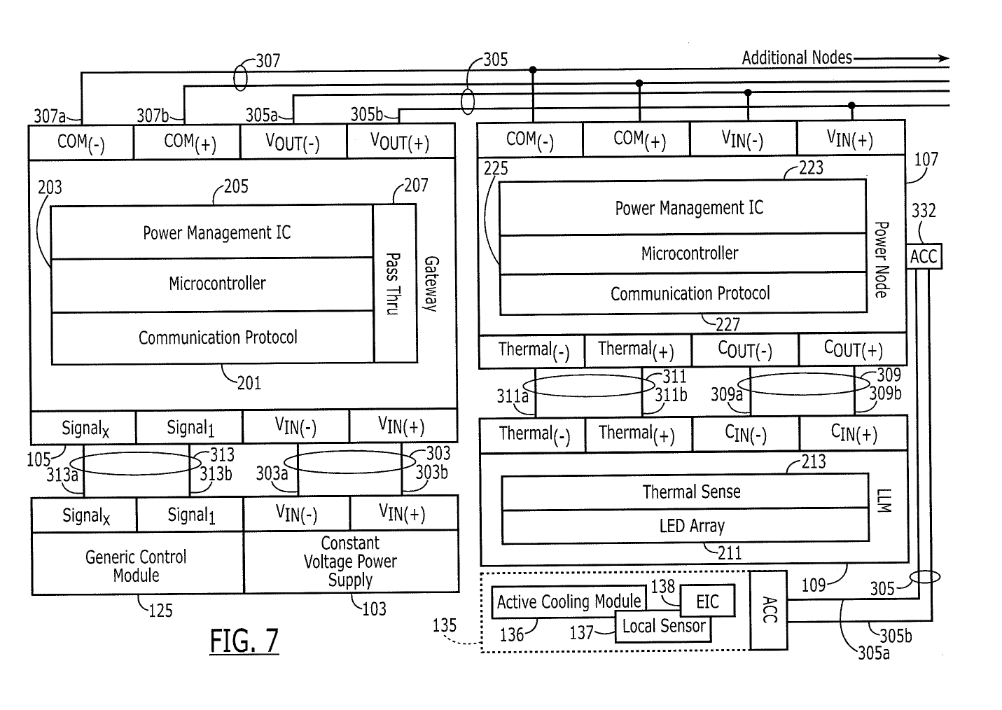

FIGS. 7 through 10 illustrate further varieties of ways in which the various components may be coupled together. For instance, FIG. 7 illustrates an embodiment similar to that of FIG. 6, except with the addition of one or more accessories associated with the LLM 213, such as an active cooling module 136, a local sensor 137 (.e.g., motion sensor), and/or others 138. In this configuration, the accessories 136, 137, and/or 138 are coupled to one or more ports 332 on the power node module 107 for receiving power directly from the voltage bus 305. That is, the accessory port or ports 332 on the power node modules 107 are coupled to the same voltage bus 305 that runs between gateway module 105 and the one or more power node modules 107 in the system.

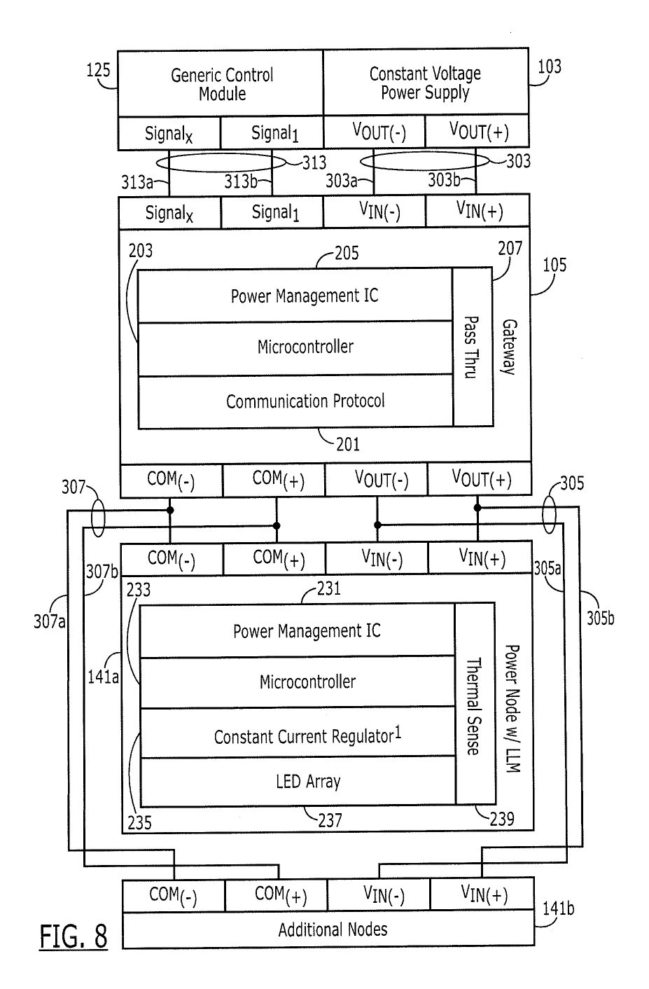

FIG. 8 is a block diagram of a very simple embodiment similar to that of FIG. 1, but illustrating how a plurality of power node modules may be coupled in parallel to the communication bus 307 and regulated D/C voltage power bus 305. In addition, for illustrative purposes, FIG. 8 illustrates an embodiment in which the power node module and LLM are incorporated into a single unit 141a. Note that the combined unit 141a comprises the power management integrated circuit 231, microcontroller 233, and constant current controller 235 associated with the power node module in FIG. 6 as well as the LED array 237 and the thermal sensing circuit 239 associated with the LLM in FIG. 6.

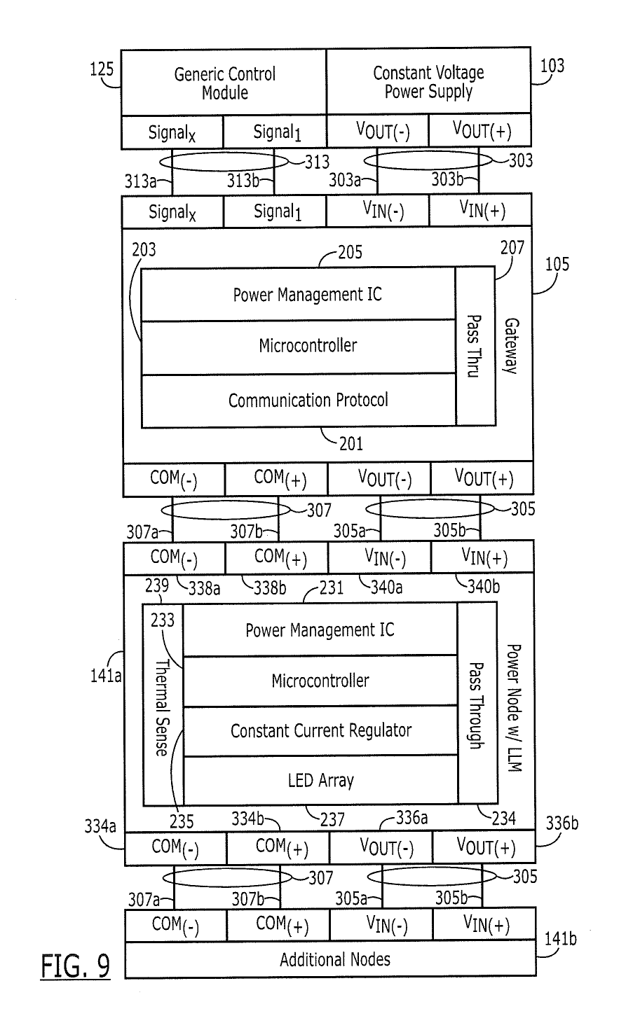

FIG. 9 shows an embodiment very similar to the embodiment of FIG. 8. The only difference between FIG. 9 and FIG. 8 is that the plurality of combined units 141a, 141b are coupled to the voltage and communication buses 305 and 307 in a pass-through or daisy-chain configuration, rather than a parallel configuration. Particularly, note that the first power node/LLM unit 141a has additional ports 334a, 334b, 336a and 336b for coupling to a next power node/LLM unit 141b. These ports 334a, 334b, 336a and 336b are coupled as pass throughs of the regulated D/C voltage and communication buses 305 and 307, respectively, that is on the ports 338a, 338b, 340a, and 340b between the gateway 105 and unit 141a.

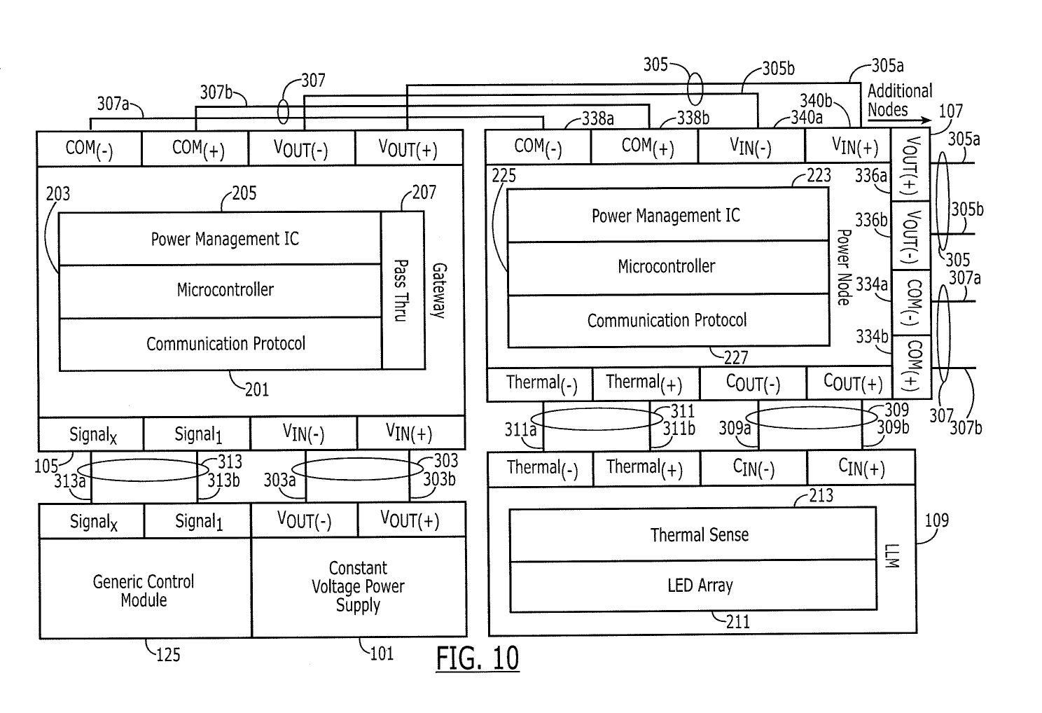

FIG. 10 illustrates one further embodiment. This embodiment is a hybrid of the embodiments of FIGS. 6 and 9. Particularly, FIG. 10 illustrates a daisy-chain embodiment (however, the additional power node modules and LLMs are not shown) essentially identical to that of FIG. 9, except that the power node module 107 and LLM 109 are physically separated (as in FIGS. 1 through 7). Like the embodiment of FIG. 9, the power node module 107 includes ports 338a and 338b for coupling to the regulated D/C voltage bus lines 305a, 305b and ports 340a and 340b for coupling to the communication bus lines 307a, 307b. It further includes pass through ports 334a, 334b, 336a, and 336b for supplying access to the communication and voltage buses to a next power node module in the system (not shown). Yet further, as in the embodiments of FIGS. 6 and 7, the power node module 107 is coupled to the LLM array 109 via the current lines 309a and 309b and the temperature data lines 311a and 311b as previously described.

Power node modules 107 or combined power node/LLM units 141 can be designed generically with the communication and regulated D/C voltage pass through ports and/or one or more accessory ports incorporated therein. Then system designers can use such parts in virtually any of the aforedescribed embodiments, simply choosing to not use any of those ports that are unnecessary for the particular design in order to reduce part counts and maximize the benefits of mass production.

The system in the present invention is very flexible and eliminates much of the difficulty of customization of power sources for different LED lighting systems inherent in the prior art. For instance, in the prior art, integrated power supplies needed to be specifically built for operating with a particular dimmer or LLM. In the present invention, a generic power supply 103 can be used for multiple applications, and only the programming in the gateway module 105 (and may be the power node module 107, depending on the embodiment) would need to be adapted to operate with the particular dimmer.

Having thus described particular embodiments of the invention, various alterations, modifications, and improvements will readily occur to those skilled in the art. Such alterations, modifications, and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A modular LED light module power system comprising:
a D/C power supply module for generating a regulated D/C voltage output;
a power node module for each LED lighting module that is to be powered by the system, each power node module including a regulated D/C voltage to regulated D/C current converter for converting the regulated D/C voltage to a regulated D/C current for powering an LED lighting module;
a gateway module coupled to receive the regulated D/C voltage from the power supply module for powering the gateway module, the gateway module including a digital processing apparatus;
a communication bus coupled between the gateway module and the power node module; and
a voltage power bus coupled between the gateway module and the power node module;
wherein the gateway module is configured to maintain the communication bus and to pass the regulated D/C voltage through to the power bus.

2. The system of claim 1 further comprising:
an LED light module comprising at least one LED and a temperature sensing circuit, the at least one LED coupled to receive the regulated D/C current from the power node module and the temperature sensing circuit coupled to transmit thermal data to the power node module.

3. The system of claim 2 wherein the power node module comprises a plurality of power node modules coupled to the voltage power bus and the communication bus.

4. The system of claim 3 wherein the gateway node is further adapted to addressably communicate with the power node modules.

5. The system of claim 1 wherein the gateway module further comprises digital signal processing apparatus for receiving lighting control data from an LED control device and issuing instructions on the communication bus to the power node module responsive to the lighting control data.

6. The system of claim 5 further comprising an LED control device coupled to transmit the lighting control data to the gateway module.

7. The system of claim 6 wherein the LED control device is a dimmer.

8. The system of claim 1 further comprising:
an LED control device coupled to receive power from the voltage power bus and further coupled on the communication bus; and
wherein the LED control device communicates with at least one of the power node module and the gateway module via the communication bus.

9. The system of claim 8 wherein the LED control device is a motion sensor.

10. The system of claim 2 further comprising an LED lighting accessory coupled to receive the regulated D/C voltage output through the power node module.

11. The system of claim 3 wherein the plurality of power node modules are coupled to the voltage power bus and to the communication bus in parallel configuration.

12. The system of claim 3 wherein the plurality of power node modules are coupled to the voltage power bus and to the communication bus in a daisy chain configuration.

13. The system of claim 1 wherein the power node module further includes an LED light and a temperature sensing circuit, the LED light coupled to receive the regulated D/C current.

14. A method of driving an LED light module comprising:
providing in a first module an A/C to D/C power supply for generating a regulated D/C voltage output from an A/C voltage input;
providing a plurality of second, power node modules each for powering an LED lighting module, each power node module including a regulated D/C voltage to regulated D/C current converter for converting the regulated D/C voltage to a regulated D/C current for powering an LED lighting module;
providing in a third module separate from the first and second modules a gateway module coupled to receive the regulated D/C voltage from the power supply module for powering the gateway module, the gateway module including a digital processing apparatus adapted to maintain a communication bus for communication with the power node, the gateway module further configured to pass the regulated D/C voltage through to the power node module on a voltage power bus;
conducting communications between the gateway module and the power node modules over the communication bus; and
transmitting the voltage power output to the power node modules via the voltage power bus.

15. The method of claim 14 wherein the gateway node addressably communicates with the power node modules via the communications bus.

16. The method of claim 14 further comprising:
the gateway module receiving lighting control data from an LED control device and issuing instructions on the communication bus to one of the power node modules responsive to the lighting control data.

17. The method of claim 14 wherein the plurality of power node modules are coupled to the communication bus and the voltage power bus in a parallel configuration.

18. The method of claim 14 wherein the plurality of power node modules are coupled to the communication bus and the voltage power bus in a daisy chain configuration.
